(19) United States
(12) Patent Application Publication
(10) Pub. No.: US 2009/0173407 A1
(43) Pub. Date: Jul. 9, 2009

(54) MULTILAYER TUBE FOR TRANSPORTING WATER OR GAS

(76) Inventors: Anthony Bonnet, Beaumont Le Roger (FR); Michael Werth, Bernay (FR)

Correspondence Address: ARKEMA INC.;PATENT DEPARTMENT - 26TH FLOOR, 2000 MARKET STREET, PHILADELPHIA, PA, 19103-3222, US

(21) Appl. No.: 12/094,807

(22) PCT Filed: Nov. 23, 2006
(86) PCT No.: PCT/FR2006/051219

§ 371 Date: Sep. 22, 2008

Related U.S. Application Data
(60) Provisional application No. 60/780,258, filed on Mar. 8, 2006.

(30) Foreign Application Priority Data
Nov. 24, 2005 (FR) 0511906

(51) Int. Cl. F16L 9/14; B32B 1/08

(52) U.S. Cl. 138/141; 428/36.7; 138/137

(57) ABSTRACT

The invention concerns a multilayer tube comprising (viewed form inside outwards of the tube): optionally a layer C₁ comprising at least one fluorinated polymer; a layer C₂ comprising at least one functionalized fluorinated polymer, optionally mixed with at least one fluorinated polymer; a barrier layer C₃ comprising a barrier polymer selected among EVOH or a mixture based on EVOH, PGA or PDMK; a layer C₄ of an adhering binder; a layer C₅ comprising at least one polyolefin, optionally mixed with at least one functionalized polyolefin; optionally a barrier layer C₆; optionally a layer C₇ comprising at least one polyolefin, optionally mixed with at least one functionalized polyolefin.

### FIELD OF THE INVENTION

The present invention relates to a multilayer pipe comprising a layer of a functionalized fluoropolymer, at least one layer of a polyolefin and at least one layer of a barrier polymer. The polyolefin may be a polyethylene, especially high-density polyethylene (HDPE) or a crosslinked polyethylene (referred to as PEX). The pipe may be used for transporting various fluids. The invention also relates to the uses of this pipe.

### TECHNICAL PROBLEM

Steel or cast iron pipes are increasingly being replaced by equivalents made of plastic. Polyolefins, especially polyethylenes, are thermoplastics that are extensively used since they have good mechanical properties, they can be transformed and allow pipes to be welded together easily. Polyolefins are widely used for the manufacture of pipes for transporting mains water or gas. When the gas is at a high pressure (>10 bar, or even higher), it is necessary for the polyolefin to be mechanically resistant to the stresses exerted by the gas under pressure.

Polyethylene may be subjected to a corrosive chemical medium. For example, in the case of transporting water, this water may contain corrosive additives or chemical products (for example ozone, chlorinated derivatives used for water purification, for instance bleach, which are oxidizing agents, especially when hot). Water additives may damage the polyolefin over time. In addition, a current major challenge is that of removing a maximum amount of germs, bacteria or microorganisms by raising the temperature of the water (>70° C.) that circulates in the pipes. The action of the water additives on the polyolefin is then all the more powerful.

One problem that the invention intends to solve is thus that of having available a plastic pipe that comprises a layer of polyolefin, especially of polyethylene, and which shows good chemical resistance with respect to the transported fluid. The pipe must especially be resistant to the chemical additives that are used in water treatment, especially when the water is hot.

Another problem that the invention intends to solve is that the pipe has barrier properties. The term “barrier” means that the pipe blocks the migration into the transported fluid of contaminants present in the external medium or of contaminants (such as antioxidants or polymerization residues) present in the polyolefin. The term “barrier” also means that the pipe blocks the migration of oxygen or of the additives present in the transported fluid into the polyolefin layer.

It is also necessary for the pipe to have good mechanical properties, in particular good impact strength, and for the layers to adhere well to each other (no delamination).

The multilayer pipe must also show good adhesion between the layers (i.e. there is no delamination), such that it conserves mechanical stability over time.

The Applicant has developed a multilayer pipe comprising at least one layer of polyolefin, which solves the posed problems.

### PRIOR ART

Document EP 1 484 346, published on Dec. 8, 2004, describes multilayer structures comprising an irradiation-grafted fluoropolymer. The structures may be in the form of bottles, tanks, containers or tubes. The structure of the multilayer pipe according to the invention does not appear in said document.

Document EP 1 541 343, published on Jun. 8, 2005, describes a multilayer structure based on a fluoropolymer modified by irradiation grafting, for storing or transporting chemical products. In said patent application, the term “chemical product” means products that are corrosive or hazardous, or alternatively products whose purity it is desired to maintain. The structure of the multilayer pipe according to the invention does not appear in said document.

Document U.S. Pat. No. 6,016,849, published on Jul. 25, 1996, describes a plastic pipe having an adhesion between the inner layer and the outer protective layer between 0.2 and 0.5 N/mm. No mention is made of a fluoropolymer modified by irradiation grafting.

Documents US 2004/0 206 413 and WO 2005/070 671 describe a multilayer pipe comprising a metal sheath. No mention is made of a fluoropolymer modified by irradiation grafting.

A multilayer pipe according to the invention is not described in these prior art documents.

### BRIEF DESCRIPTION OF THE INVENTION

The invention relates to a multilayer pipe as described in claim 1 and also to the uses of the pipe in the transportation of various fluids. The invention also relates more generally to a multilayer structure combining the same layers C₁ to C₇, this structure possibly being in the form of a hollow body, a container, a bottle, etc.

The invention may be understood more clearly on reading the detailed description that follows, of the nonlimiting examples of implementation thereof, and on examining the attached FIGURE. The prior French patent application FR 05.11906 and also the provisional patent application U.S. 60/780,258, the priorities of which are claimed, are incorporated herein by reference.

### FIGURE

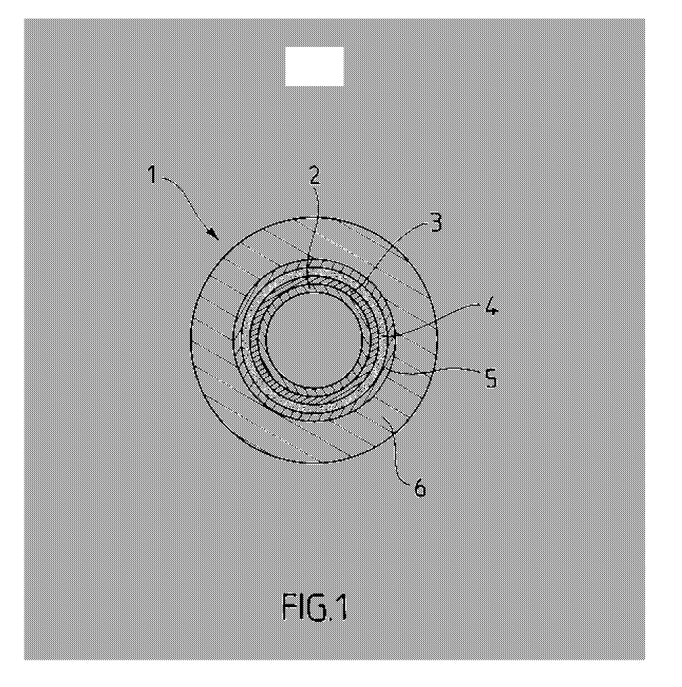

FIG. 1 is a view in cross section of a multilayer pipe 1 according to the invention. It is the cylindrical pipe of example 1 having the following concentric layers, referenced from 2 to 6:
layer 2: layer of PVDF;
layer 3: layer of functionalized PVDF;
layer 4: layer of EVOH;
layer 5: layer of functionalized polyolefin;
layer 6: layer of PEX.

The layers are arranged next to each other in the indicated order 2→6. The innermost layer is the layer of PVDF, and the outermost layer is the layer of PEX.

### DETAILED DESCRIPTION OF THE INVENTION

As regards the functionalized fluoropolymer, it is a fluoropolymer bearing at least one functional group chosen from the following groups: carboxylic acid, carboxylic acid salt, carbonate, carboxylic acid anhydride, epoxide, carboxylic acid ester, silyl, alkoxysilane, carboxylic acid amide, hydroxyl, isocyanate. The functional group is introduced into the fluoropolymer either via copolymerization or via grafting of a monomer bearing a functional group as defined.

The functionalized fluoropolymer may be obtained by copolymerizing a fluoromonomer with at least one monomer bearing functional group and optionally at least one other comonomer. For example, the functionalized polymer may be a PVDF comprising monomer units of VDF and of a monoesterified unsaturated diacid or of vinylene carbonate, as is described in document U.S. Pat. No. 5,415,958. Another example of a functionalized fluoropolymer is that of a PVDF comprising monomer units of VDF and of itaconic or citraconic anhydride, as is described in document U.S. Pat. No. 6,703,465 B2. The functionalized fluoropolymer is prepared via an emulsion, suspension or solution process.

The functionalized fluoropolymer may also be obtained by irradiation grafting of an unsaturated monomer (described later) onto a fluoropolymer. In this case, this material will be referred to for simplicity as an irradiation-grafted fluoropolymer.

As regards the irradiation-grafted fluoropolymer, it is obtained via a process of irradiation grafting of at least one unsaturated monomer onto a fluoropolymer (described later). This material will be referred to for simplicity as an irradiation-grafted fluoropolymer.

The fluoropolymer is premixed with the unsaturated monomer via any melt-blending technique known to those skilled in the art. The mixing step is performed in any mixing device such as extruders or blenders used in the thermoplastics industry. Preferably, an extruder will be used to form the mixture into granules. The grafting thus takes place on a mixture (in bulk) and not at the surface of a powder as is described, for example, in document U.S. Pat. No. 5,576,106.

Next, the mixture of the fluoropolymer and of the unsaturated monomer is irradiated (beta β or gamma γ irradiation) in the solid state using an electron or photon source at an irradiation dose of between 10 and 200 kGray and preferably between 10 and 150 kGray. The mixture may be packaged, for example, in polyethylene bags, the air is extracted and the bags are then sealed. Advantageously, the dose is between 2 and 6 Mrad and preferably between 3 and 5 Mrad. The irradiation generated by means of a cobalt-60 bomb is particularly preferred.

The content of unsaturated monomer that is grafted is, on a weight basis, between 0.1% and 5% (i.e. the grafted unsaturated monomer corresponds to 0.1 to 5 parts per 99.9 to 95 parts of fluoropolymer), advantageously from 0.5% to 5% and preferably from 0.9% to 5%. The content of grafted unsaturated monomer depends on the initial content of the unsaturated monomer in the fluoropolymer/unsaturated monomer mixture to be irradiated. It also depends on the efficacy of the grafting, and thus on the irradiation time and energy.

The unsaturated monomer that has not been grafted and the residues released by the grafting, especially HF, may then be optionally removed. This last step may be made necessary if the ungrafted unsaturated monomer is liable to harm the adhesion, or alternatively owing to toxicology problems. This operation may be performed according to the techniques known to those skilled in the art. Degassing under vacuum may be applied, while optionally applying heating at the same time. It is also possible to dissolve the modified fluoropolymer in a suitable solvent, for instance N-methylpyrrolidone, and then to precipitate the polymer in a nonsolvent, for example in water or in an alcohol, or alternatively to wash the modified fluoropolymer using a solvent that is inert with respect to the fluoropolymer and the grafted functions. For example, when maleic anhydride is grafted on, washing may be performed with chlorobenzene.

One of the advantages of this irradiation-grafting process is, specifically, that of obtaining higher contents of grafted unsaturated monomer than with the standard grafting processes using a radical initiator. Thus, typically, with the irradiation-grafting process, it is possible to obtain contents of greater than 1% (1 part of unsaturated monomer per 99 parts of fluoropolymer), or even greater than 1.5%, which is not possible with a standard grafting process in an extruder.

Moreover, the irradiation grafting takes place “under cool conditions”, typically at temperatures below 100° C. or even 50° C., such that the mixture of the fluoropolymer and of the unsaturated monomer is not in molten form as for a standard grafting process in an extruder. One essential difference is thus that, in the case of a semicrystalline fluoropolymer (as is the case, for example, with PVDF), the grafting takes place in the amorphous phase and not in the crystalline phase, whereas uniform grafting takes place in the case of melt-grafting in an extruder. The unsaturated monomer is therefore not identically distributed on the chains of the fluoropolymer in the case of irradiation grafting and in the case of grafting in an extruder. The modified fluoro product thus has a distribution different than the unsaturated monomer on the chains of the fluoropolymer, when compared with a product that would be obtained via grafting in an extruder.

During this grafting step, it is preferable to avoid the presence of oxygen. Flushing the fluoropolymer/unsaturated monomer mixture with nitrogen or argon is thus possible to remove the oxygen.

The fluoropolymer modified by irradiation grafting shows the very good chemical resistance and resistance to oxidation, and also the good thermomechanical strength, of the fluoropolymer before its modification.

As regards the fluoropolymer, any polymer containing in its chain at least one monomer chosen from compounds containing a vinyl group capable of opening to be polymerized and which contains, directly attached to this vinyl group, at least one fluorine atom, one fluoroalkyl group or one fluoroalkoxy group, is thus denoted.

Examples of monomers that may be mentioned include vinyl fluoride; vinylidene fluoride (VDF, CH₂═CF₂); trifluoroethylene (VF₃); chlorotrifluoroethylene (CTFE); 1,2-difluoroethylene; tetrafluoroethylene (TFE); hexafluoropropylene (HFP); perfluoro(alkyl vinyl)ethers such as perfluoro(methyl vinyl)ether (PMVE), perfluoro(ethyl vinyl)ether (PEVE) and perfluoro(propyl vinyl)ether (PPVE); perfluoro(1,3-dioxole); perfluoro(2,2-dimethyl-1,3-dioxole) (PDD); the product of formula CF₂═CFOCF₂CF(CF₃)OCF₂CF₂X in which X is SO₂F, CO₂H, CH₂OH, CH₂OCN or CH₂OPO₃H; the product of formula CF₂═CFOCF₂CF₂SO₂F; the product of formula F(CF₂)ₙCH₂OCF═CF₂ in which n is 1, 2, 3, 4 or 5; the product of formula R₁CH₂OCF═CF₂ in which R₁ is hydrogen where F(CF₂)z and z is 1, 2, 3 or 4; the product of formula R₃OCF═CH₂ in which R₃ is F(CF₂)_{z}— and z is 1, 2, 3 or 4; perfluorobutylethylene (PFBE); 3,3,3-trifluoropropene and 2-trifluoromethyl-3,3,3-trifluoro-1-propene.

The fluoropolymer may be a homopolymer or a copolymer, and may also comprise nonfluoromonomers such as ethylene.

By way of example, the fluoropolymer is chosen from:
vinylidene fluoride homopolymers and copolymers (PVDF) preferably containing at least 50% by weight of VDF, the copolymer being chosen from chlorotrifluoroethylene (CTFE), hexafluoropropylene (HFP), trifluoroethylene (VF₃) and tetrafluoroethylene (TFE);
copolymers of TFE and of ethylene (ETFE);
trifluoroethylene (VF₃) homopolymers and copolymers;
copolymers, and especially terpolymers, combining residues of chlorotrifluoroethylene (CTFE), tetrafluoroethylene (TFE), hexafluoropropylene (HFP) and/or ethylene units and optionally VDF and/or VF₃ units.

Advantageously, the fluoropolymer is a PVDF homopolymer or copolymer. Specifically, this fluoropolymer shows good chemical resistance, especially to UV and to chemical products, and is easy to transform (more easily than PTFE or copolymers of ETFE type). Preferably, the PVDF contains, on a weight basis, at least 50%, more preferentially at least 75% and better still at least 85% VDF. The comonomer is advantageously HFP.

Advantageously, the PVDF has a viscosity ranging from 100 Pa·s to 3000 Pa·s, the viscosity being measured at 230° C., at a shear rate of 100 s⁻¹ using a capillary rheometer. Specifically, these PVDFs are particularly suited to extrusion and injection. Preferably, the PVDF has a viscosity ranging from 300 Pa·s to 1200 Pa·s, the viscosity being measured at 230° C., at a shear rate of 100 s⁻¹ using a capillary rheometer.

Thus, the PVDFs sold under the brand name Kynar® 710 or 720 are entirely suitable for this formulation.

As regards the unsaturated monomer that is grafted onto the fluoropolymer, this monomer contains a C═C double bond and also at least one polar function that may be a function among the following:
carboxylic acid,
carboxylic acid salt,
carboxylic acid anhydride,
epoxide,
carboxylic acid ester,
silyl,
alkoxysilane,
carboxylic amide,
hydroxyl,
isocyanate.

Mixtures of several unsaturated monomers may also be envisioned.

Unsaturated carboxylic acids containing 4 to 10 carbon atoms, and functional derivatives thereof, particularly the anhydrides thereof, are particularly preferred unsaturated monomers. Examples of unsaturated monomers that may be mentioned include methacrylic acid, acrylic acid, maleic acid, fumaric acid, itaconic acid, citraconic acid, undecylenic acid, allylsuccinic acid, cyclohex-4-ene-1,2-dicarboxylic acid, 4-methyl-cyclohex-4-ene-1,2-dicarboxylic acid, bicyclo(2,2,1)hept-5-ene-2,3-dicarboxylic acid, x-methylbicyclo(2,2,1)hept-5-ene-2,3-dicarboxylic acid, zinc, calcium or sodium undecylenate, maleic anhydride, itaconic anhydride, citraconic anhydride, dichloromaleic anhydride, difluoromaleic anhydride, itaconic anhydride, crotonic anhydride, glycidyl acrylate or methacrylate, allyl glycidyl ether, vinylsilanes such as vinyltrimethoxysilane, vinyltriethoxysilane, vinyltriacetoxysilane and γ-methacryloxypropyltrimethoxysilane.

Other examples of unsaturated monomers include C₁-C₈ alkyl esters or glycidyl ester derivatives of unsaturated carboxylic acids such as methyl acrylate, methyl methacrylate, ethyl acrylate, ethyl methacrylate, butyl acrylate, butyl methacrylate, glycidyl acrylate, glycidyl methacrylate, monoethyl maleate, diethyl maleate, monomethyl fumarate, dimethyl fumarate, monomethyl itaconate and diethyl itaconate; amide derivatives of unsaturated carboxylic acids such as acrylamide, methacrylamide, maleic monoamide, maleic diamide, maleic N-monoethylamide, maleic N,N-diethylamide, maleic N-monobutylamide, maleic N,N-dibutylamide, fumaric monoamide, fumaric diamide, fumaric N-monoethylamide, fumaric N,N-diethylamide, fumaric N-monobutylamide and fumaric N,N-dibutylamide; imide derivatives of unsaturated carboxylic acids such as maleimide, N-butylmaleimide and N-phenylmaleimide; and metal salts of unsaturated carboxylic acids such as sodium acrylate, sodium methacrylate, potassium acrylate, potassium methacrylate and zinc, calcium or sodium undecylenate.

Excluded from the unsaturated monomers are those containing two C═C double bonds that might lead to crosslinking of the fluoropolymer, for instance di- or triacrylates. From this point of view, maleic anhydride and also zinc, calcium and sodium undecylenates constitute good graftable compounds since they have little tendency to homopolymerize or even to give rise to crosslinking.

Maleic anhydride is advantageously used. The reason for this is that this monomer offers the following advantages:
it is solid and may be readily introduced with the fluoropolymer granules before melt blending,
it affords good adhesion properties,
it is particularly reactive with respect to the functions of a functionalized polyolefin, especially when these functions are epoxide functions,
unlike other unsaturated monomers such as (meth)acrylic acid or acrylic esters, it does not homopolymerize and does not need to be stabilized.

In the mixture that is to be irradiated, the proportion of fluoropolymer is, on a weight basis, between 80% and 99.9% per, respectively, 0.1% to 20% of unsaturated monomer. Preferably, the proportion of fluoropolymer is from 90% to 99% per, respectively, 1% to 10% of unsaturated monomer.

As regards the polyolefin, this term denotes a polymer predominantly comprising ethylene and/or propylene units.

It may be a polyethylene homo- or copolymer, the comonomer being chosen from propylene, butene, hexene and octene. It may also be a polypropylene homo- or copolymer, the comonomer being chosen from ethylene, butene, hexene and octene.

The polyethylene may especially be high-density polyethylene (HDPE), low-density polyethylene (LDPE), linear low-density polyethylene (LLDPE) or very-low-density polyethylene (VLDPE). The polyethylene may be obtained using a Ziegler-Natta or Phillips catalyst or a catalyst of metallocene type, or alternatively via the high-pressure process. The polypropylene is an isotactic or syndiotactic polypropylene.

It may also be a crosslinked polyethylene (referred to as PEX). Compared with a noncrosslinked PE, PEX has better mechanical properties (especially good resistance to cracking) and better chemical resistance. The crosslinked polyethylene may be, for example, a polyethylene comprising hydrolyzable silane groups (as described in patent applications WO 01/53367 or US 2004/0127641 A1) which has then been crosslinked after reaction of the silane groups with each other. The reaction of the silane groups Si—OR with each other leads to Si—O—Si bonds that link the polyethylene chains together. The content of hydrolyzable silane groups may be at least 0.1 hydrolyzable silane group per 100 —CH₂— units (determined via infrared analysis). The polyethylene may also be crosslinked by means of radiation, for example gamma radiation. It may also be a polyethylene that is crosslinked by means of a radical initiator of peroxide type. A PEX of type A (crosslinking by means of a radical initiator), of type B (crosslinking by means of silane groups) or of type C (irradiation crosslinking) may thus be used.

It may also be a “bimodal” polyethylene, i.e. a product composed of a mixture of polyethylenes with different average molecular masses, as taught in document WO 00/60001. Bimodal polyethylene affords, for example, a very advantageous compromise between impact strength and “stress-cracking” resistance, and also good rigidity and good pressure resistance.

For pipes that need to withstand pressure, especially pipes for transporting gas under pressure or for transporting water, it will be advantageously possible to use a polyethylene that has good resistance to slow crack generation (SCG) and to rapid crack propagation (RCP). The grade HDPE XS 10 B sold by Total Petrochemicals has good resistance to cracking (slow or rapid). It is an HDPE containing hexene as comonomer, having a density of 0.959 g/cm³ (ISO 1183), an MI-5 of 0.3 dg/minute (ISO 1133) an HLMI of 8 dg/minute (ISO 1133), a long-lasting hydrostatic resistance of 11.2 MPa, according to ISO/DIS 9080, and a resistance to slow crack generation on notched tubes of greater than 1000 hours according to ISO/DIS 13479.

As regards the functionalized polyolefin, this term denotes a copolymer of ethylene and of at least one unsaturated polar monomer. This monomer is preferably chosen from:
C₁-C₈ alkyl (meth)acrylates, especially methyl, ethyl, propyl, butyl, 2-ethylhexyl, isobutyl or cyclohexyl (meth)acrylate;
unsaturated carboxylic acids and salts and anhydrides thereof, especially acrylic acid, methacrylic acid, maleic anhydride, itaconic anhydride and citraconic anhydride;
unsaturated epoxides, especially aliphatic glycidyl esters and ethers such as allyl glycidyl ether, vinyl glycidyl ether, glycidyl maleate and itaconate, glycidyl acrylate and methacrylate, and also alicyclic glycidyl esters and ethers;
vinyl esters of saturated carboxylic acids, especially vinyl acetate or vinyl propionate.

The functionalized polyolefin may be obtained by copolymerization of ethylene and of at least one unsaturated polar monomer chosen from the above list. The functionalized polyolefin may be a copolymer of ethylene and of a polar monomer from the above list or alternatively a terpolymer of ethylene and of two unsaturated polar monomers chosen from the above list. The copolymerization is performed at high pressures of greater than 1000 bar according to the “high-pressure” process. The functional polyolefin obtained by copolymerization comprises, on a weight basis, from 50% to 99.9%, preferably from 60% to 99.9% and even more preferentially from 65% to 99% ethylene, and from 0.1% to 50%, preferably from 0.1% to 40% and even more preferentially from 1% to 35% of at least one polar monomer from the above list.

For example, the functionalized polyolefin is a copolymer of ethylene and of unsaturated epoxide, preferably glycidyl (meth)acrylate, and optionally of a C₁-C₈ alkyl (meth)acrylate or of a vinyl ester of a saturated carboxylic acid. The content of unsaturated epoxide, especially of glycidyl (meth)acrylate, is between 0.1% and 50%, advantageously between 0.1% and 40%, preferably between 1% and 35% and even more preferentially between 1% and 20%. They may be, for example, functionalized polyolefins sold by the company Arkema under the references Lotader® AX8840 (8 wt % of glycidyl methacrylate, 92 wt % of ethylene, melt index 5 according to ASTM D1238), Lotader® AX8900 (8 wt % of glycidyl methacrylate, 25 wt % of methyl acrylate, 67 wt % of ethylene, melt index 6 according to ASTM D1238) or Lotader® AX8950 (9 wt % of glycidyl methacrylate, 15 wt % of methyl acrylate, 76 wt % of ethylene, melt index 85 according to ASTM D1238).

The functionalized polyolefin may also be a copolymer of ethylene and of an unsaturated carboxylic acid anhydride, preferably maleic anhydride, and optionally of a C₁-C₈ alkyl (meth)acrylate or of a vinyl ester of a saturated carboxylic acid. The content of maleic anhydride, especially maleic anhydride, is between 0.1% and 50%, advantageously between 0.1% and 40%, preferably between 1% and 35% and even more preferentially between 1% and 10%. They may be, for example, functionalized polyolefins sold by the company Arkema under the references Lotader® 2210 (2.6 wt % of maleic anhydride, 6 wt % of butyl acrylate and 91.4 wt % of ethylene, melt index 3 according to ASTM D1238), Lotader® 3340 (3 wt % of maleic anhydride, 16 wt % of butyl acrylate and 81 wt % of ethylene, melt index 5 according to ASTM D1238), Lotader® 4720 (0.3 wt % of maleic anhydride, 30 wt % of ethyl acrylate and 69.7 wt % of ethylene, melt index 7 according to ASTM D1238), Lotader® 7500 (2.8 wt % of maleic anhydride, 20 wt % of butyl acrylate and 77.2 wt % of ethylene, melt index 70 according to ASTM D1238), Orevac® 9309, Orevac® 9314, Orevac® 9307Y, Orevac® 9318, Orevac® 9304 or Orevac® 9305.

The term “functionalized polyolefin” also denotes a polyolefin onto which is radical-grafted an unsaturated polar monomer from the above list. The grafting takes place in an extruder or in solution in the presence of a radical initiator. Examples of radical initiators that may be used include t-butyl hydroperoxide, cumene hydroperoxide, diisopropylbenzene hydroperoxide, di-t-butyl peroxide, t-butylcumyl peroxide, dicumyl peroxide, 1,3-bis(t-butylperoxyisopropyl)benzene, benzoyl peroxide, isobutyryl peroxide, bis(3,5,5-trimethyl)hexanoyl peroxide or methyl ethyl ketone peroxide. The grafting of an unsaturated polar monomer onto a polyolefin is known to those skilled in the art: for further details, reference may be made, for example, to documents EP 689 505, U.S. Pat. No. 5,235,149, EP 658 139, U.S. Pat. No. 6,750,288 B2 and U.S. Pat. No. 6,528,587 B2. The polyolefin onto which the unsaturated polar monomer is grafted may be a polyethylene, especially high-density polyethylene (HDPE) or low-density polyethylene (LDPE), linear low-density polyethylene (LLDPE) or very-low-density polyethylene (VLDPE). The polyethylene may be obtained using a Ziegler-Natta or Phillips catalyst or a catalyst of metallocene type, or alternatively via the high-pressure process. The polyolefin may also be a polypropylene, especially an isotactic or syndiotactic polypropylene. It may also be a copolymer of ethylene and of propylene of EPR type, or a terpolymer of ethylene, of a propylene and of a diene of EPDM type. They may be, for example, functionalized polyolefins sold by the company Arkema under the references Orevac® 18302, 18334, 18350, 18360, 18365, 18370, 18380, 18707, 18729, 18732, 18750, 18760, PP-C and CA100.

The polymer onto which the unsaturated polar monomer is grafted may also be a copolymer of ethylene and of at least one unsaturated polar monomer chosen from:
C₁-C₈ alkyl (meth)acrylates, especially methyl, ethyl, propyl, butyl, 2-ethylhexyl, isobutyl or cyclohexyl (meth)acrylate;
vinyl esters of saturated carboxylic acids, especially vinyl acetate or vinyl propionate.

They may be, for example, functionalized polyolefins sold by the company Arkema under the references Orevac® 18211, 18216 or 18630.

The multilayer pipes are now described in greater detail. The multilayer pipe comprises (in order from the interior to the exterior of the pipe):
optionally a layer C₁ comprising at least one fluoropolymer;
a layer C₂ comprising at least one functionalized fluoropolymer, optionally mixed with at least one fluoropolymer;
a barrier layer C₃ comprising a barrier polymer chosen from EVOH or an EVOH-based mixture, PGA or PDMK;
a layer C₄ of an adhesion binder;
a layer C₅ comprising at least one polyolefin, optionally mixed with at least one functionalized polyolefin;
optionally a barrier layer C₆;
optionally a layer C₇ comprising at least one polyolefin, optionally mixed with at least one functionalized polyolefin.

The inner layer that is in contact with the circulating fluid is either layer C₁ or layer C₂. The layers of the pipe are preferably all concentric. The pipe is preferably cylindrical. Preferably, the layers are arranged next to each other in the indicated order (i.e., for example, layer C₃ is in contact with layer C₂ and layer C₄) and the layers adhere to each other in their respective contact zones.

### Advantages of the Multilayer Pipe

The multilayer pipe:
advantageously has chemical resistance with respect to the transported fluid (via layer C₁ and/or C₂);
has low permeability with respect to numerous molecules;
and thus retards or prevents the migration of these molecules from the interior to the exterior or from the exterior to the interior of the pipe;
has good mechanical properties and also good adhesion between the layers (no delamination).

### Layer C₁

This layer is optional and comprises at least one fluoropolymer. Preferably, the fluoropolymer is a PVDF homo- or copolymer or alternatively a copolymer based on VDF and on TFE of the EFEP type. Preferably, this layer is present when the fluid is water.

### Layer C₂

This layer comprises at least one functionalized fluoropolymer optionally mixed with a fluoropolymer. The functionalized fluoropolymer serves as binder between layer C₁ and layer C₃. Layer C₂ is advantageously directly attached to layer C₁. Preferably, the functionalized fluoropolymer is an irradiation-grafted fluoropolymer.

The functionalized fluoropolymer of layer C₂ may be used alone or mixed with a fluoropolymer.

### As Regards the Mixture of the Functionalized Fluoropolymer and of the Fluoropolymer

The mixture comprises, on a weight basis, from 1% to 99%, advantageously from 10% to 90% and preferably from 10% to 50% of functionalized fluoropolymer per, respectively, 99% to 1%, advantageously 90% to 10% and preferably 50% to 90% of fluoropolymer. Advantageously, the functionalized fluoropolymer and the fluoropolymer are of the same nature. For example, it may be a PVDF modified by irradiation grafting and an unmodified PVDF.

The Applicant has found that by selecting the functionalized fluoropolymer and/or the fluoropolymer, it is possible to obtain very strong adhesion between layer C₂ and layer C₃. In this case, the adhesion is moreover cohesive. For this, a fluoropolymer that is flexible is used, i.e. a fluoropolymer having a tensile modulus of between 50 and 1000 MPa (measured according to standard ISO R 527 at 23° C.), advantageously between 100 and 750 MPa and preferably between 200 and 600 MPa. Preferably, the viscosity of the flexible fluoropolymer (measured with a capillary rheometer at 230° C. at 100 s⁻¹) is between 100 and 1500 Pa·s, advantageously between 200 and 1000 Pa·s and preferably between 500 and 1000 Pa·s. Preferably, the crystallization temperature of the flexible fluoropolymer (measured by DSC according to standard ISO 11357-3) is between 50 and 120° C. and preferably between 85 and 110° C. Preferably, the flexible fluoropolymer is a PVDF copolymer, more particularly a copolymer of VDF and of HFP.

Preferably, the viscosity of the functionalized fluoropolymer (measured with a capillary rheometer at 230° C. at 100 s⁻¹) is between 100 and 1500 Pa·s, advantageously between 200 and 1000 Pa·s and preferably between 500 and 1000 Pa·s.

Preferably, the functionalized fluoropolymer is an irradiation-grafted PVDF obtained from a PVDF comprising, on a weight basis, at least 80%, advantageously at least 90%, preferably at least 95% and even more preferentially at least 98% VDF. Most preferably, the irradiation-grafted PVDF is obtained from a PVDF homopolymer (i.e. a homopolymer containing 100% VDF).

A particularly preferred mixture thus comprises an irradiation-grafted PVDF homopolymer and a VDF-HFP copolymer with a tensile modulus of between 200 and 600 MPa, a crystallization temperature between 85 and 110° C. and a viscosity of between 500 and 1000 Pa·s.

### Barrier Layer C₃

The function of C₃ is to retard or prevent the migration of molecules from the interior to the exterior (which is the case, for example, for a fuel transfer pipe) or alternatively from the exterior to the interior of the multilayer structure (which is the case, for example, for a pipe for transporting water or gas).

Layer C₃ comprises a barrier polymer that is chosen from EVOH or an EVOH-based mixture, poly(glycolic acid) (PGA) and polydimethyl ketene (PDMK).

EVOH is also known as saponified ethylene-vinyl acetate copolymer. It is a copolymer with an ethylene content of from 10 mol % to 70 mol %. Preferably, good barrier properties are obtained when the ethylene content is between 25 mol % and 60 mol %. Preferably, the degree of saponification of its vinyl acetate component is at least 85 mol %, preferably at least 90 mol % and even more preferentially at least 95 mol %. The ethylene contents and the degree of saponification may be determined, for example, by NMR. EVOH constitutes a good oxygen barrier. Advantageously, EVOH has a melt flow index of between 0.5 and 100 and preferably between 5 and 30 g/10 minutes (230° C., 2.26 kg). It is understood that EVOH may contain small proportions of other comonomer ingredients, including α-olefins such as propylene, isobutene, α-octene, unsaturated carboxylic acids or their salts, partial alkyl esters, full alkyl esters, etc. It is also possible to combine two types of EVOH to improve the barrier and/or mechanical properties.

EVOH is an effective barrier material for many molecules, as shown by Table I, which compares several grades of EVOH (as a function of their ethylene content) with directed PP or PET.

TABLE I

| | Gas permeability at 20° C. | | | | |
|---|---|---|---|---|---|
| Ethylene | on dry film (cc 20 μm/m² | | | Permeability at 20° | |
| content | day atm) | | | (mg/cm² day) | |
| (mol %) | N₂ | O₂ | CO₂ | Chloroform | Kerosene |
| Soarnol 29 | 0.018 | 0.23 | 0.49 | | |
| mol % | | | | | |
| Soarnol 32 | 0.024 | 0.3 | 0.62 | 0.20 | <0.005 |
| mol % | | | | (20 μm) | (20 μm) |
| Soarnol 38 | 0.041 | 0.53 | 1.3 | | |
| mol % | | | | | |
| Soarnol 44 | 0.1 | 1.2 | 4.4 | 0.31 | <0.005 |
| mol % | | | | (20 μm) | (20 μm) |
| OPP | 600 | 1400 | 10500 | | |
| PET | 7.8 | 30 | 96 | 0.87 | <0.005 |
| | | | | (25 μm) | (25 μm) |

* data taken from the website www.soarnol.com

For the EVOH-based mixtures, EVOH forms the matrix, i.e. it represents at least 40% and preferably at least 50% by weight of the mixture.

The polydimethyl ketene may be obtained by pyrolysis of isobutyric anhydride as envisioned in patent applications FR 2 851 562 and FR 2 851 562, which are incorporated herein by reference. A process for producing polydimethyl ketene is as follows: a) a mixture comprising 1% to 50% by volume of isobutyric anhydride per, respectively, 99% to 50% of an inert gas is preheated at atmospheric pressure to between 300 and 340° C., b) this mixture is then maintained at a temperature of between 400 and 550° C. for a time of between 0.05 and 10 seconds to obtain a mixture of dimethyl ketene, inert gas, isobutyric acid and unreacted isobutyric anhydride, c) the above flux is cooled to separate the dimethyl ketene and the inert gas from the isobutyryl alcohol and the isobutyric anhydride, d) the dimethyl ketene is absorbed in a solvent of saturated or unsaturated, substituted or unsubstituted, aliphatic or alicyclic hydrocarbon type, and the dimethyl ketene polymerization is then initiated using a cationic catalysis system that is soluble in this solvent, comprising an initiator, a catalyst and a cocatalyst, e) at the end of the polymerization, the unreacted dimethyl ketene is removed and the polydimethyl ketene is separated from the solvent and from the rest of the catalytic system. The catalyst may be, for example, AlBr₃, the initiator is, for example, tert-butyl chloride, and the cocatalyst is, for example, o-chloranil.

PGA is poly(glycolic acid), i.e. a polymer containing, on a weight basis, at least 60%, advantageously 70% and preferably 80% of units (1) below:

(—O—CH₂—C(═O)—) (1)

This polymer may be manufactured by heating to a temperature of between 120 and 250° C. 1,4-dioxane-2,5-dione in the presence of a catalyst such as a tin salt, for instance SnCl₄. The polymerization is performed in bulk or in a solvent. The PGA may contain the other units (2) to (6) below:

(—O—(CH₂)ₙ—O—C(═O)—(CH₂)ₘ—C(═O)) (2)

with n being an integer between 1 and 10 and m an integer between 0 and 10;

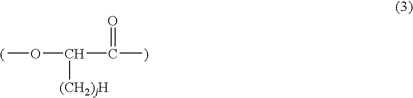

with j being an integer between 1 and 10;

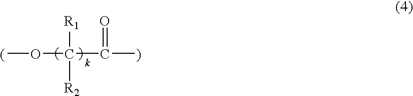

in which k is an integer between 2 and 10 and R₁ and R₂ each denote, independently of each other, H or a C₁-C₁₀ alkyl group;

(—OCH₂CH₂CH₂—O—C(═O)—) (5)

or

(—O—CH₂—O—CH₂CH₂—) (6)

PGA is described in European patent EP 925915 B1.

EVOH or an EVOH-based mixture is the preferred barrier polymer.

### Layer C₄

Layer C₄, which is arranged between layers C₃ and C₅, serves to reinforce the adhesion between these two layers. It comprises an adhesion binder, i.e. a polymer whose function is to improve the adhesion between these two layers.

Preferably, the adhesion binder comprises at least one functionalized polyolefin, optionally mixed with at least one polyolefin. Layer C₄ comprises at least one functionalized polyolefin optionally mixed with at least one polyolefin. The mixture comprises, on a weight basis, from 1% to 100%, advantageously from 10% to 100% and preferably from 50% to 100% of at least one functionalized polyolefin per, respectively, 0 to 99%, advantageously 0 to 90% and preferably 0 to 50% of at least one polyolefin. The polyolefin that is used for the mixture with the functionalized polyolefin is preferably a polyethylene, since these two polymers show good compatibility.

Layer C₄ may also comprise a mixture of two or more functionalized polyolefins. For example, it may be a mixture of a copolymer of ethylene and of an unsaturated epoxide and optionally of an alkyl (meth)acrylate and of a copolymer of ethylene and of an alkyl (meth)acrylate.

Preferably, the functionalized polyolefin of layer C₄ preferably contains functions capable of reacting with the functions that are on EVOH, PGA or PDMK. Thus, a functionalized polyolefin bearing anhydride and/or acid functions may be suitable for use in particular in the presence of EVOH. It may be, for example, a copolymer:
of ethylene
and
of an unsaturated carboxylic acid anhydride, preferably maleic anhydride, or of an unsaturated carboxylic acid, preferably (meth)acrylic acid
and
optionally of a C₁-C₈ alkyl (meth)acrylate or of a vinyl ester of a saturated carboxylic acid.

It may also be a polyolefin or a copolymer of ethylene and of at least one unsaturated polar monomer chosen from:
C₁-C₈ alkyl (meth)acrylates, especially methyl, ethyl, propyl, butyl, 2-ethylhexyl, isobutyl or cyclohexyl (meth)acrylate;
vinyl esters of saturated carboxylic acids, especially vinyl acetate or vinyl propionate,
   onto which has been radical-grafted an unsaturated carboxylic acid anhydride or an unsaturated carboxylic acid.

### Layer C₅

Layer C₅ comprises at least one polyolefin optionally mixed with at least one functionalized polyolefin. More specifically, the mixture comprises, on a weight basis, from 1% to 100%, advantageously from 10% to 100% and preferably from 50% to 100% of at least one polyolefin per, respectively, 0 to 99%, advantageously 0 to 90% and preferably 0 to 50% of at least one functionalized polyolefin.

Preferably, layer C₅ does not comprise any functionalized polyolefin and the polyolefin used is preferably a polyethylene, advantageously a PEX.

### Barrier Layer C₆

The function of C₆ is identical to that of C₃. The two barrier layers afford a barrier structure that is more effective and/or that has barrier properties with respect to a larger number of molecules. The barrier layer C₆ may comprise:
EVOH or an EVOH-based mixture;
polydimethyl ketene (PDMK);
poly(glycolic acid) (PGA).

Preferably, barrier layer C₆ is a metal sheath. Besides its barrier function, the metal sheath also has the function of reinforcing the mechanical strength of the pipe. Another advantage of using a metal sheath is that the pipe can be bent or deformed without resuming its initial position under the effect of the mechanical stresses generated by the thermoplastic polymer layers. The metal may be steel, copper or aluminum or an aluminum alloy. It is preferably aluminum or an aluminum alloy for reasons of corrosion resistance and suppleness. The metal sheath is manufactured according to one of the processes known to those skilled in the art. Reference may be made especially to the following documents that describe processes for producing plastic/metal composite pipes: U.S. Pat. No. 6,822,205, EP 0 581 208 A1, EP 0 639 411 B1, EP 0 823 867 B1, EP 0 920 972 A1. The process used preferably consists in:
conforming around a plastic pipe a strip of metal having longitudinal edges bent toward a common side and placed supporting each other extending substantially parallel to the longitudinal axis of the plastic pipe,
the longitudinal edges are then welded together. They thus form a longitudinal welding joint.

After the longitudinal edges of the metal strip have been welded together, a tubular metal sheath is thus obtained.

### Adhesion Binder

To improve the adhesion of barrier layer C₆, a layer comprising an adhesion binder is advantageously placed between layer C₅ and the barrier layer C₆ and/or between the barrier layer C₆ and the optional layer C₇. The adhesion binder is, for example, a functionalized polyolefin bearing anhydride and/or acid functions. It is, for example, a copolymer:
of ethylene
and
of an unsaturated carboxylic acid anhydride, preferably maleic anhydride, or of an unsaturated carboxylic acid, preferably (meth)acrylic acid
and
optionally of a C₁-C₈ alkyl (meth)acrylate or of a vinyl ester of a saturated carboxylic acid.

It may also be a polyolefin or a copolymer of ethylene and of at least one unsaturated polar monomer chosen from:
C₁-C₈ alkyl (meth)acrylates, especially methyl, ethyl, propyl, butyl, 2-ethylhexyl, isobutyl or cyclohexyl (meth)acrylate;
vinyl esters of saturated carboxylic acids, especially vinyl acetate or vinyl propionate,
   onto which has been radical-grafted an unsaturated carboxylic acid anhydride or an unsaturated carboxylic acid.

Preferably, the adhesion binder is a polyolefin onto which is radical-grafted an unsaturated carboxylic acid anhydride or an unsaturated carboxylic acid, preferably maleic anhydride. It may be a polyethylene onto which is grafted (meth)acrylic acid or maleic anhydride or a polypropylene onto which is grafted (meth)acrylic acid or maleic anhydride. Examples that may be mentioned include the functionalized polyolefins sold by the company Arkema under the references Orevac® 18302, 18303s, 18334, 18350, 18360, 18365, 18370, 18380, 18707, 18729, 18732, 18750, 18760, PP-C or CA100 or by the company Uniroyal Chemical under the reference Polybond® 1002 or 1009 (polyethylene onto which is grafted acrylic acid).

### Layer C₇

The pipe may optionally comprise a layer C₇ comprising at least one polyolefin, optionally mixed with a functionalized polyolefin. The polyolefins used in layers C₅ and C₇ may be identical or different.

The polyolefin layer C₇ has the function of mechanically protecting the pipe. Preferably, layer C₇ does not comprise any functionalized polyolefin and the polyolefin used is preferably a polyethylene, and advantageously a PEX.

It would not constitute a departure from the context of the invention if each of the layers of the multilayer pipe, especially the layer(s) of polyolefin, contained additives usually used as a mixture with thermoplastics, for example antioxidants, lubricants, colorants or carbon black. The pipe may also comprise other layers, for instance a heat-insulating layer around the multilayer pipe.

According to one preferred form (best mode), the multilayer pipe comprises (in order from the interior to the exterior of the pipe):
optionally a layer C₁ comprising at least one PVDF homo- or copolymer;
a layer C₂ comprising at least one PVDF onto which has been irradiation-grafted an unsaturated carboxylic acid anhydride, preferably maleic anhydride, optionally mixed with at least one compatible PVDF homo- or copolymer;
a layer C₃ comprising at least one EVOH;
a layer C₄ comprising an adhesion binder;
a layer C₅ comprising at least one polyethylene, preferably a PEX;
optionally a layer C₆ as described previously;
optionally a layer C₇ as described previously.

### Extensions of the Invention to Other Forms of Multilayer Structures

The invention may be extended to other forms of multilayer structures. Thus, the invention more generally relates to a multilayer structure comprising (in order from the interior to the exterior) layers C₁ to C₇ as described, each layer being arranged next to another in the indicated order. This multilayer structure may be in the form of a hollow body, a container, a bottle, etc. It may be, for example, a fuel tank. The technique of extrusion-blow molding (or blow-molding of a hollow body) or of injection-blow molding is used.

### Thickness of the Layers

Preferably, layers C₁, C₂, C₃, C₄ and C₆ each have a thickness of between 0.01 and 30 mm, advantageously between 0.05 and 20 mm and preferably between 0.05 and 10 mm. Layers C₅ and C₇ each preferably have a thickness of between 0.01 and 10 000 mm, advantageously between 0.5 and 2000 mm and preferably between 0.5 and 1000 mm.

### Production of the Pipes

The pipes free of metal sheath are manufactured by coextrusion. When the polyolefin of layer C₅ and/or of the optional layer C₇ is a PEX of type B (crosslinking via silane groups), the process is commenced by extruding the noncrosslinked polyolefin. The crosslinking is performed by then immersing the extruded pipes into pools of hot water. When the polyolefin of layer C₅ and/or of the optional layer C₇ is a PEX of type A (crosslinking with the aid of a radical initiator), the crosslinking is performed using a radical initiator that is activated thermally during the extrusion.

The pipes with a metal sheath are manufactured after coextrusion of layers C₁ to C₅, and of the optional layer of adhesion binder between layer C₆ and layer C₅, and a strip of metal is then wound around the layers thus obtained. The longitudinal edges may be welded together to form a longitudinal welding joint. The other layers, i.e. the optional layer C₇ and, if layer C₇ is present, optionally a layer of adhesion binder between layer C₆ and C₇, may then be extruded, if this is envisioned.

### Use of the Pipes

The multilayer pipe may be used for transporting various fluids. The pipe is suitable for transporting water, especially hot water, in particular for transporting hot water in a network. The pipe may be used for transporting hot heating water (temperature greater than 60° C., or even 90° C.). One advantageous example of application is that of heating radiating from the floor (underfloor heating) in which the pipe used for conveying the hot water is laid under the ground or the floor. The water is heated by a boiler and conveyed through the pipe. Another example is that in which the pipe serves to convey hot water to a radiator. The pipe may thus be used for radiative water-based heating systems. The invention also relates to a networked heating system comprising the pipe of the invention.

The chemical resistance of the pipe is suited to water containing chemical additives (generally in small amounts, of less than 1%) that may impair polyolefins, especially polyethylene, especially when hot. These additives may be oxidizing agents such as chlorine and hypochlorous acid, chlorinated derivatives, bleach, ozone, etc.

For applications in which the circulating water is drinking water, water intended for medical or pharmaceutical applications or a biological fluid, it is preferable to have a layer of unmodified fluoropolymer as layer in contact with the water (layer C₁). Microorganisms (bacteria, germs, molds, etc.) have little tendency to grow on a fluoropolymer, especially on PVDF. Furthermore, it is preferable for the layer in contact with the water or the biological fluid to be a layer of unmodified fluoropolymer rather than a layer of modified fluoropolymer, to avoid the migration of nongrafted (free) unsaturated monomer into the water or the biological fluid.

The barrier properties of the pipe make it usable for transporting water in polluted land by blocking the migration of contaminants into the transported fluid. The barrier properties are also useful for preventing the migration of oxygen into the water (DIN 4726), which may be detrimental when the pipe is used for transporting hot heating water (the presence of oxygen is a cause of corrosion of the steel or iron components of the heating installation). It is also desired to block the migration of the contaminants present in the polyolefin layer (antioxidants, polymerization residues, etc.) into the transported fluid.

More generally, the multilayer pipe may be used for transporting chemical products, especially those capable of chemically degrading polyolefins.

The multilayer pipe may also be used for transporting a gas, especially a gas under pressure. When the polyolefin is a polyethylene of PE80 type or a PE100, it is especially suited for resistance at pressures above 10 bar, or even above 20 bar, or even above 30 bar. The gas may be of a different nature. It may be, for example:
a gaseous hydrocarbon (for example mains gas, a gaseous alkane, especially ethane, propane, butane, a gaseous alkene, especially ethylene, propylene or butene),
nitrogen,
helium,
hydrogen,
oxygen,
a gas that is corrosive or capable of degrading polyethylene or polypropylene. For example, it may be an acidic or corrosive gas, such as H₂S or HCl or HF.

Mention will also be made of the advantage of these pipes for applications associated with air-conditioning, in which the circulating gas is a cryogen. It may be CO₂, especially supercritical CO₂, or HFC or HCFC gas. The optional layer C₁ or layer C₂ show good resistance to these gases since they are fluoropolymers. Preferably, the fluoropolymer of layers C₁ and C₂ is PVDF, since it has particularly good resistance. It is possible that the cryogen condenses at certain points in the air-conditioning circuit and is liquid. The multilayer pipe may thus also apply to the case where the cryogenic gas has condensed in liquid form.

### The Fluid May Also be a Fuel, for Example a Petroleum Spirit

The multilayer pipe may also be used for transporting a fuel, for example a petroleum spirit, especially a petroleum spirit containing an alcohol. The petroleum spirit may be, for example, spirit M15 (15% methanol, 42.5% toluene and 42.5% isooctane), Fuel C (50% toluene, 50% isooctane), CE10 (10% ethanol and 90% of a mixture containing 45% toluene and 45% isooctane). It may also be MTBE.

### EXAMPLES

The examples that follow illustrate the invention according to the best form (best mode) envisioned by the inventors. They are given merely as illustrations and do not limit the scope of the invention.

### Products Used

PEX: the layer of PEX was obtained from a mixture containing 95% of grade Borpex ME-2510 and 5% of grade MB-51 sold by Borealis.

Kynar® 2750-10: PVDF sold by the company Arkema, with a melt-flow index of 20 g/10 minutes (230° C., 5 kg) and a melting point of about 135° C.

Kynar® 720: PVDF homopolymer from the company Arkema, with a melt-flow index of 20 g/10 minutes (230° C., 5 kg) and a melting point of about 170° C.

Kynar® 710: PVDF homopolymer from the company Arkema, with a melt-flow index of 25 g/10 minutes (230° C., 5 kg) and a melting point of about 170° C.

PVDF-1: Kynar® 710 onto which has been irradiation-grafted maleic anhydride. The grafting was performed by mixing, in a twin-screw extruder, Kynar® 710 with 2% by weight of maleic anhydride. The mixture is granulated and then bagged in leaktight aluminum bags, and the bags and the mixture thereof are then irradiated at 3 Mrad using a cobalt-60 bomb for 17 hours. The product is recovered and degassed under vacuum to remove the residual ungrafted maleic anhydride. The content of grafted maleic anhydride is 1% (infrared spectroscopy). The MFR of the PVDF-1 is 15 g/10 minutes (230° C., 5 kg).

Orevac® 18303s polyethylene grafted with maleic anhydride having an MFI of 2 (190° C., 2.16 kg) and a melting point of 124° C.

Soarnol® 2903 DT: EVOH sold by the company Nippon Gohsei, comprising 29 mol % of ethylene, with an MFI of 3.2 (210° C., 2.16 kg), a melting point equal to about 188° C. and a crystallization temperature of about 163° C. It has an oxygen permeability of 0.4 cc 20 μm/m² day atm at 20° C.

### Example 1

### According to the Invention

Pipe: PEX_{outer layer} (800 μm)/Orevac® (50 μm)/Soarnol 2903 DT (50 μm)/[70% Kynarflex®+30% PVDF-1] (50 μm)/Kynar® 720_{inner layer} (100 μm)

On a pipe extruder of McNeil type allowing the coextrusion of 5 layers, a pipe is prepared by coextruding, in the order from the exterior of the pipe to the interior of the pipe, the following layers: 800 μm of the mixture ME-2510/MB-51, 50 μm of Orevac® 18303s, 50 μm of EVOH, 50 μm of a mixture containing 70 wt % of Kynar Flex® 2750-10 and 30 wt % of PVDF-1, and finally 100 μm of Kynar® 720. The pipe is coextruded with a head temperature in the region of 240° C. and a line speed of 15 m/minute. The pipes thus obtained are placed in a pool heated to about 70° C. for 1 day to crosslink the PE. The layer of Kynar® 720 is the inner layer and the layer of PEX is the outer layer.

The adhesion obtained by circumferential peeling is 55 N/cm at the EVOH/Orevac® interface. No adhesion value is measurable between the (PVDF-1+2750-10) mixture and the EVOH since the adhesion is excellent and the interface cannot be primed.

### Example 2

### According to the Invention

Pipe: PEX_{outer layer} (800 μm)/Orevac® (50 μm)/Soarnol 2903 DT (50 μm)/[50% Kynarflex®+50% PVDF-1] (50 μm)/Kynar® 720_{inner layer} (100 μm)

On a pipe extruder of McNeil type allowing the coextrusion of 5 layers, a pipe is prepared by coextruding, in the order from the exterior to the interior, 800 μm of the mixture ME-2510/MB-51, 50 μm of Orevac® 18303s, 50 μm of EVOH, 50 μm of a mixture containing 50 wt % of Kynar Flex® 2750-10 and 50 wt % of PVDF-1, and finally 100 μm of Kynar® 720. The pipe is coextruded with a head temperature in the region of 240° C. and a line speed of 15 m/minute. The pipes thus obtained are placed in a pool heated to about 70° C. for 1 day to crosslink the PE. The layer of Kynar® 720 is the inner layer and the layer of PEX is the outer layer.

The adhesion obtained by circumferential peeling is 57 N/cm at the EVOH/Orevac® interface. No adhesion value is measurable between the (PVDF-1+2750-10) mixture and the EVOH since the adhesion is excellent and the interface cannot be primed.

### Example 3

### According to the Invention

Pipe: PEX_{outer layer} (800 μm)/Orevac® (50 μm)/Soarnol 2903 DT (50 μm)/[30% Kynarflex®+70% PVDF-1] (50 μm)/Kynar® 720_{inner layer} (100 μm)

On a pipe extruder of McNeil type allowing the coextrusion of 5 layers, a pipe is prepared by coextruding, in the order from the exterior to the interior, 800 μm of polyethylene, 50 μm of Orevac® 18303s, 50 μm of EVOH, 50 μm of a mixture containing 30 wt % of Kynar Flex® 2750-10 and 70 wt % of PVDF-1, and finally 100 μm of Kynar® 720. The pipe is coextruded with a head temperature in the region of 240° C. and a line speed of 15 m/minute. The pipes thus obtained are placed in a pool heated to about 70° C. for 1 day to crosslink the PE. The layer of Kynar® 720 is the inner layer and the layer of PEX is the outer layer. The adhesion obtained by circumferential peeling is 56 N/cm at the EVOH/Orevac® interface. No adhesion value is measurable between the (PVDF-1+2750-10) mixture and the EVOH since the adhesion is excellent and the interface cannot be primed.

1. A multilayer pipe comprising (in the order from the interior to the exterior of the pipe):
optionally a layer C₁ comprising at least one fluoropolymer;
a layer C₂ comprising at least one functionalized fluoropolymer, optionally mixed with at least one fluoropolymer;
a barrier layer C₃ comprising a barrier polymer chosen from ethylene vinyl alcohol (EVOH) or a mixture based on EVOH, poly(glycolic acid) (PGA) and polydimethyl ketene (PDMK);
a layer C₄ of an adhesion binder;
a layer C₅ comprising at least one polyolefin, optionally mixed with at least one functionalized polyolefin;
optionally a barrier layer C₆;
optionally a layer C₇ comprising at least one polyolefin, optionally mixed with at least one functionalized polyolefin.

2. The multilayer pipe as claimed in claim 1, in which the layers adhere to each other in their respective contact zones.

3. The multilayer pipe as claimed in claim 1, in which the fluoropolymer of layer C₁ and/or of layer C₂ is a polymer containing in its chain at least one monomer chosen from compounds containing a vinyl group capable of opening to be polymerized and which contains, directly attached to this vinyl group, at least one fluorine atom, one fluoroalkyl group or one fluoroalkoxy group.

4. The multilayer pipe as claimed in claim 1, in which the fluoropolymer of layer C₁ and/or of layer C₂ is a VDF homo- or copolymer containing at least 50% by weight of VDF, or alternatively an EFEP.

5. The multilayer pipe as claimed in claim 1, in which the functionalized fluoropolymer is a fluoropolymer onto which is irradiation-grafted at least one unsaturated monomer.

6. The multilayer pipe as claimed in claim 5, in which the fluoropolymer onto which is grafted the unsaturated monomer is a vinylidene fluoride (VDF) homo- or copolymer containing at least 50% by weight of VDF.

7. The multilayer pipe as claimed in claim 5, in which the unsaturated monomer grafted onto the fluoropolymer contains a C═C double bond and also at least one polar function which may be a carboxylic acid, carboxylic acid salt, carboxylic acid anhydride, epoxide, carboxylic acid ester, silyl, alkoxysilane, carboxylic amide, hydroxyl or isocyanate function.

8. The multi layer pipe as claimed in claim 5, in which the unsaturated monomer grafted onto the fluoropolymer is an unsaturated carboxylic acid containing from 4 to 10 carbon atoms and functional derivatives thereof.

9. The multilayer pipe as claimed in claim 5, in which the unsaturated monomer which is grafted is selected from the group consisting of methacrylic acid, acrylic acid, maleic acid, fumaric acid, itaconic acid, citraconic acid, undecylenic acid, allylsuccinic acid, cyclohex-4-ene-1,2-dicarboxylic acid, 4-methyl-cyclohex-4-ene-1,2-dicarboxylic acid, bicyclo(2,2,1)hept-5-ene-2,3-dicarboxylic acid, x-methylbicyclo(2,2,1)hept-5-ene-2,3-dicarboxylic acid, zinc, calcium or sodium undecylenate, maleic anhydride, itaconic anhydride, citraconic anhydride, dichloromaleic anhydride, difluoromaleic anhydride, itaconic anhydride, crotonic anhydride, glycidyl acrylate or methacrylate, allyl glycidyl ether, vinylsilanes, vinyltrimethoxysilane, vinyltriethoxysilane, vinyltriacetoxysilane and γ-methacryloxypropyltrimethoxysilane, and mixtures thereof.

10. The multilayer pipe of claim 1, in which the barrier layer C₆ comprises:
EVOH or an EVOH-based mixture;
polydimethyl ketene (PDMK);
poly(glycolic acid) (PGA).

11. The multilayer pipe as claimed in claim 1, in which the barrier layer C₆ is a metal sheath.

12. A multilayer pipe comprising (in the order from the interior to the exterior of the pipe):
optionally a layer C₁ comprising at least one polyvinylidene fluoride (PVOH) homo- or copolymer;
a layer C₂ comprising at least one PVDF onto which has been irradiation-grafted an unsaturated carboxylic acid anhydride, preferably maleic anhydride, optionally mixed with at least one compatible PVDF homo- or copolymer;
a layer C₃ comprising at least one EVOH;
a layer C₄ comprising an adhesion binder;
a layer C₅ comprising at least one polyethylene;
optionally a barrier layer C₆ as described in claim 10;
optionally a layer C₇ comprising at least one polyolefin, optionally mixed with at least one functionalized polyolefin.

13. The multilayer pipe as claimed in claim 1, in which the adhesion binder of C₄ comprises at least one functionalized polyolefin, optionally mixed with at least one polyolefin.

14. The multilayer pipe as claimed in claim 13, in which the functionalized polyolefin of layer C₄ preferably contains functions capable of reacting with the functions that are on EVOH, PGA or PDMK.

15. The multilayer pipe as claimed in claim 13, in which the functionalized polyolefin bears anhydride and/or acid functions.

16. The multilayer pipe as claimed in claim 13, in which the functionalized polyolefin is a copolymer of ethylene and of an unsaturated carboxylic acid anhydride, or of an unsaturated carboxylic acid, and optionally of a C₁-C₈ alkyl (meth)acrylate or of a vinyl ester of a saturated carboxylic acid.

17. The multilayer pipe as claimed in claim 1, in which a layer of adhesion binder is placed between C₅ and C₆ and/or between C₆ and C₇.

18. The use of a pipe as defined in claim 1, for transporting water, hot water, chemical products, or a gas, or fuel.

19. (canceled)

20. The use of the pipe of claim 18, for conveying hot water in heating radiating from the floor or for conveying hot water to a radiating component.

21. The use of the pipe of claim 18, in radiative heating systems.

22. The use as claimed in claim 18, wherein the gas is a gaseous hydrocarbon, nitrogen, helium, hydrogen, oxygen, a gas that is corrosive or capable of degrading polyethylene or polypropylene, or a cryogen.

23. (canceled)

24. (canceled)
